(19) United States
(12) Patent Application Publication
(10) Pub. No.: US 2020/0114604 A1
(43) Pub. Date: Apr. 16, 2020

(54) APPARATUS AND METHOD FOR MAKING A SILICONE ARTICLE

(71) Applicant: SAINT-GOBAIN PERFORMANCE PLASTICS CORPORATION, Solon, OH (US)

(72) Inventors: Aijun ZHU, Romeoville, IL (US); Adam P. NADEAU, Boylston, MA (US); Heidi LENNON, Shrewsbury, MA (US)

(21) Appl. No.: 16/710,794

(22) Filed: Dec. 11, 2019

Related U.S. Application Data
(62) Division of application No. 13/967,101, filed on Aug. 14, 2013.
(60) Provisional application No. 61/683,130, filed on Aug. 14, 2012.

(51) Int. Cl. B29D 23/00; C08L 83/04; C08G 77/20; B29C 48/08; B29C 48/09; B29C 48/465; B29C 48/91; B29C 48/36; B29C 48/395; B29C 48/37; B29C 48/29; B29C 35/10

(52) U.S. Cl. CPC B29D 23/00; C08L 83/04; C08G 77/20; B29C 48/08; B29C 48/09; B29C 48/465; B29C 71/02; B29C 48/362; B29C 48/397; B29C 48/37; B29C 48/29; B29C 35/10; Y10T 428/139; B29C 48/91

(57) ABSTRACT

An apparatus for forming a silicone article is disclosed. The apparatus includes an pumping system to deliver the silicone formulation to a die, the silicone formulation having a viscosity of less than about 2,000,000 centipoise; the die having a distal end, a proximal end, and a channel there between, wherein the silicone formulation flows through the channel of the die; and a source of radiation energy, wherein the radiation energy substantially cures the silicone formulation as the silicone formulation flows out the channel of the die to form the silicone article. The present disclosure further includes a method of forming the silicone article, a silicone tube, and a silicone extrudate.

### CROSS-REFERENCE TO RELATED APPLICATION

This application is a divisional of and claims priority under 35 U.S.C. § 120 to U.S. patent application Ser. No. 13/967,101 entitled “APPARATUS AND METHOD FOR MAKING A SILICONE ARTICLE”, by Aijun ZHU et al., filed Aug. 14, 2013, which claims priority under 35 U.S.C. § 119(e) to U.S. Provisional Patent Application No. 61/683,130 entitled “APPARATUS AND METHOD FOR MAKING A SILICON ARTICLE”, by Aijun Zhu et al., filed Aug. 14, 2012, both of which are assigned to the current assignee hereof and incorporated herein by reference in their entireties.

### FIELD OF THE DISCLOSURE

The disclosure, generally, is related to an apparatus and method of forming a silicone article.

### BACKGROUND

Many industries utilize silicone tubing for the delivery and removal of fluids because silicone tubing is non-toxic, flexible, thermally stable, has low chemical reactivity, and can be produced in a variety of sizes when compared with tubing made from other materials. For example, silicone tubing may be used in a variety of industries such as the medical industry, pharmaceutical industry, food delivery, and the like.

Conventionally, silicone tubing is extruded with high consistency rubber (HCR) silicones utilizing infrared (IR) heat and/or forced hot air. Conventional high consistency rubber (HCR) has a viscosity much higher than 2,000,000 centipoise and is typically heat cured and suitable for processes including molding, extrusion, calendaring, and the like. However, tubing cured via conventional heating is limited by temperature tolerable by silicones without degradation and rate of heat transfer. Further, a typical hot air vulcanization (HAV) tower used for cure consumes a lot of energy. Additionally, the extrusion process followed by heat cure typically forms bubbles within the tubing, which are aesthetically undesirable, and forms less dimensionally accurate tubes along the length of the tube.

In an alternative, tubing may be produced via an injection molding process with liquid injection molding (LIM) or liquid silicone rubber (LSR) silicones, which have much lower viscosities than an HCR. However, injection molded tubes have physical artifacts that can be undesirable, such as parting lines and/or knit lines that form when mold components meet. Additionally, the processes used to form molded tubes can be expensive and lack flexibility because new moldings need to be produced each time a change is made to the dimensions of the tubing. Furthermore, molded tubes can only be produced in finite lengths. Accordingly, manufacturers of tubing can be reluctant to utilize molding processes to produce silicone tubing due to the expense and lack of flexibility of these processes and the undesirable appearance of visible artifacts produced by these processes.

High viscosity silicone materials, such as high consistency gum rubber (HCR) having a viscosity greater than 2,000,000 centipoise, may also be extruded and cured via ultraviolet light. The ultraviolet cure provides a lower temperature cure compared to the conventional heat cure process. Unfortunately, the high viscosity of the high consistency gum rubber provides a limited silicone material choice for the extrusion and ultraviolet cure process. For instance, the processing of high consistency gum rubber is problematic with the addition of certain fillers. High viscosity also makes extrusion more difficult, requiring greater pumping and potentially slower production rates. Although it would be desirable to choose low viscosity silicone materials for certain applications, lower viscosity silicone polymers have yet to be processed via extrusion and cured via ultraviolet radiation.

Accordingly, an improved method and apparatus to form silicone articles are desired.

### SUMMARY

In an embodiment, an apparatus for forming a silicone article is disclosed. The apparatus includes a pumping system to deliver a silicone formulation to a die, the silicone formulation having a viscosity of less than about 2,000,000 centipoise; the die having a distal end, a proximal end, and a channel there between, wherein the silicone formulation flows through the channel of the die; and a source of radiation energy, wherein the radiation energy substantially cures the silicone formulation as the silicone formulation flows out the channel of the die to form the silicone article.

In another embodiment, a method of forming a silicone article is provided. The method includes providing a silicone formulation within a pumping system, wherein the silicone formulation has a viscosity of less than about 2,000,000 centipoise; providing a die having a distal end, a proximal end, and a channel there between; delivering the silicone formulation from the pumping system and through the channel of the die; and irradiating the silicone formulation with a radiation source to substantially cure the silicone formulation as the silicone formulation flows out the channel of the die to form the silicone article.

In yet another embodiment, an extruded silicone tube is provided. The extruded silicone tube includes a distal end, a proximal end, and a lumen there through having a continuous length from the distal end to the proximal end of at least about 0.5 meters; wherein the silicone tube comprises a cured silicone formulation having a viscosity of less than about 2,000,000 centipoise prior to cure.

In yet a further embodiment, a silicone extrudate is provided. The silicone extrudate includes a configuration of a film, a block, a circular tube, a rectangular tube, or a profile; wherein the silicone extrudate comprises a radiation cured silicone formulation having a viscosity of less than about 2,000,000 centipoise prior to cure.

### BRIEF DESCRIPTION OF THE DRAWINGS

The present disclosure may be better understood, and its numerous features and advantages made apparent to those skilled in the art by referencing the accompanying drawings.

FIG. 1 is a flow diagram of a process to make a silicone article according to an embodiment.

FIG. 2 is a diagram of an embodiment of a pumping system to make a silicone article.

FIG. 3 is a view of an exemplary die.

FIGS. 4A and 4B are capability plots for exemplary silicone tubing for an inner diameter (ID) and a wall thickness, respectively.

FIGS. 5A and 5B are capability plots for comparison high consistency rubber tubing for an inner diameter (ID) and a wall thickness, respectively.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are open-ended terms and should be interpreted to mean “including, but not limited to . . . .” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 25° C. For instance, values for viscosity are at 25° C., unless indicated otherwise.

The disclosure generally relates to an apparatus for forming a silicone article. The apparatus includes a pumping system to deliver a silicone formulation to a die. The die has a distal end, a proximal end, and a channel there between, wherein the silicone formulation flows through the channel of the die. The apparatus further includes a source of radiation energy, wherein the radiation energy substantially cures the silicone formulation as the silicone formulation flows out the channel of the die to form a silicone article. In an embodiment, the radiation energy may be provided to the silicone formulation within the pumping system, while the silicone formulation is within the die, to the silicone formulation directly after the die, or any combination thereof. In a particular embodiment, the cure of the silicone rubber as the silicone rubber flows out of the channel provides a silicone article with improved physical properties. Further, the apparatus provides an improved method for producing the silicone article.

A “silicone article” as used herein includes a silicone elastomer. In an exemplary embodiment, the silicone article is formed from a silicone formulation that includes a non-polar silicone polymer component. In an exemplary embodiment, the silicone formulation has a low viscosity prior to cure. “Low viscosity” as used herein refers to a silicone formulation having a viscosity lower than about 2,000,000 centipoise, such as lower than about 1,000,000 centipoise, prior to cure. In an embodiment, the viscosity of the silicone formulation is about 50,000 centipoise to about 2,000,000 centipoise, such as about 100,000 centipoise to about 2,000,000 centipoise, such as about 100,000 centipoise to about 1,000,000 centipoise, or even about 100,000 centipoise to about 500,000 centipoise, prior to cure. In an embodiment, the viscosity is about 200,000 centipoise (cPs) to about 2,000,000 cPs, such as about 200,000 cPs to about 1,000,000 cPs, such as about 500,000 cPs to about 800,000 cPs, prior to cure. In an embodiment, the low viscosity silicone formulation is a liquid silicone rubber (LSR) or a liquid injection molding silicone (LIM), a room temperature vulcanizing silicone (RTV), or a combination thereof. In a particular embodiment, the low viscosity silicone formulation is a liquid silicone rubber or a liquid injection molding silicone.

The silicone formulation may, for example, include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polydimethylsiloxane. In a further embodiment, the polyalkylsiloxane is a vinyl-containing polydimethylsiloxane. In yet another embodiment, the silicone polymer is a combination of a hydride-containing polydimethylsiloxane and a vinyl-containing polydimethylsiloxane. In an example, the silicone polymer is non-polar and is free of halide functional groups, such as chlorine and fluorine, and of phenyl functional groups. Alternatively, the silicone polymer may include halide functional groups or phenyl functional groups. For example, the silicone polymer may include fluorosilicone or phenylsilicone.

The silicone formulation may further include a catalyst. Typically, the catalyst is present to initiate the crosslinking process. Any reasonable catalyst that can initiate crosslinking when exposed to a radiation source is envisioned. Typically, the catalyst is dependent upon the silicone formulation. In a particular embodiment, the catalytic reaction includes aliphatically unsaturated groups reacted with Si-bonded hydrogen in order to convert the addition-crosslinkable silicone composition into the elastomeric state by formation of a network. The catalyst is activated by the radiation source and initiates the crosslinking process.

Any catalyst is envisioned depending upon the silicone formulation, with the proviso that at least one catalyst can initiate crosslinking when exposed to the radiation source, such as ultraviolet radiation. In an embodiment, a hydrosilylation reaction catalyst may be used. For instance, an exemplary hydrosilylation catalyst is an organometallic complex compound of a transition metal. In an embodiment, the catalyst includes platinum, rhodium, ruthenium, the like, or combinations thereof. In a particular embodiment, the catalyst includes platinum. In a specific embodiment, the catalyst is a platinum complex having an alkyl group, an aryl group, or combination thereof. For instance, the platinum complex is an alkyl-platinum complex having the formula, R₃Pt(IV)Cp, wherein R is a C1-6 alkyl group. In a particular embodiment, the alkyl-platinum complex is (Trimethyl)methylcyclopentadienyl platinum (IV).

In an exemplary embodiment, the catalyst is chosen to control the cure time, depending on the starting silicone material, the final properties desired, as well as the rate of cure desired for the curing process. For instance, in an embodiment when the silicone formulation is exposed to the radiation source within the pumping system, the cure rate should allow the silicone formulation to continue to flow through the pumping system and exit the die while it is curing. In another embodiment, the cure rate should be more rapid when the silicone formulation is exposed to the radiation source within the die or as it directly exits the die.

Further optional catalysts may be used with the hydrosilylation catalyst. Exemplary optional catalysts may include peroxide, tin, or combinations thereof. Alternatively, the silicone formulation further includes a peroxide catalyzed silicone formulation. In another example, the silicone formulation may be a combination of a platinum catalyzed and peroxide catalyzed silicone formulation. Any catalyst or combination thereof may be envisioned depending upon the affect of the catalyst on the silicone formulation as well as the processing conditions. For instance, the catalyst or combination thereof may be manipulated by varying the amount, catalyst chosen, or combination thereof to adjust the reaction rate of the silicone formulation.

The silicone formulation may further include an additive. Any reasonable additive is envisioned. Exemplary additives may include, individually or in combination, a vinyl polymer, a hydride, a filler, an initiator, an inhibitor, a colorant, a pigment, a carrier material, or any combination thereof. In an embodiment, the material content of the silicone article is essentially 100% silicone formulation. In some embodiments, the silicone formulation consists essentially of the respective silicone polymer described above. As used herein, the phrase “consists essentially of” used in connection with the silicone formulation precludes the presence of non-silicone polymers that affect the basic and novel characteristics of the silicone formulation, although, commonly used processing agents and additives may be used in the silicone formulation.

In an embodiment, the silicone formulation may be a room temperature vulcanizable (RTV) formulation or a gel. In a particular embodiment, the silicone formulation may be a room temperature vulcanizable formulation that is platinum cured. In a particular example, the silicone formulation may be a liquid silicone rubber (LSR). In a further embodiment, the silicone formulation is an LSR formed from a two-part reactive system.

The silicone formulation may include a conventional, commercially prepared silicone formulation. The commercially prepared silicone formulation typically includes components such as the non-polar silicone polymer, the catalyst, a filler, and optional additives. Any reasonable filler and additives are envisioned. In some instances, the filler can include silicone dioxide (SiO₂). Additionally, the filler is present in any reasonable amount. For instance, the filler is present at up to about 80% by weight, such as about 10% by weight to about 50% by weight, or even about 20% by weight to about 30% by weight of the total weight of the silicone formulation. Typically, the filler is present at a lesser amount used compared to a low viscosity silicone formulation processed by a conventional extrusion and heat cure. In a further embodiment, the filler is present at a less amount used compared to a high consistency rubber (HCR) formulation, such as an extruded high consistency rubber formulation. Furthermore, the final cured silicone article has a higher chemical crosslink to filler ratio compared to a conventional high consistency rubber, such as a conventional extruded high consistency rubber formulation. In a more particular embodiment, the comparisons to other materials such as HCR are for similar articles having equivalent durometers after cure. Although not to be bound by theory, it is believed that the increased speed of cure from the radiation energy makes low viscosity extrusion possible, hence provides a final silicone article where less filler can be used within the silicone formulation compared to a silicone article that is thermally cured. In an exemplary embodiment, the silicone formulation is substantially free of a filler. “Substantially free” as used herein refers to a silicone formulation that has less than about 1.0% by weight of the total weight of the silicone formulation. In an embodiment, the crosslink density is about 0.002 mmole/gram to about 0.2 mmole/gram, such as about 0.006 mmole/gram to about 0.1 mmole/gram, or even about 0.01 mmole/gram to about 0.03 mmole/gram.

In an exemplary embodiment, a commercially prepared silicone formulation is available as a two-part reactive system. For instance, part 1 typically includes a vinyl-containing polydialkylsiloxane, a filler, and catalyst. Part 2 typically includes a hydride-containing polydialkylsiloxane and optionally, a vinyl-containing polydialkylsiloxane and other additives. A reaction inhibitor may be included in Part 1 or Part 2. Mixing Part 1 and Part 2 by any suitable mixing method produces the silicone formulation. In an example, the mixing device is a mixer, such as a dough mixer, Ross mixer, two-roll mill, or Brabender mixer. Particular embodiments of a commercially prepared liquid silicone rubber (LSR) include Wacker Elastosil® LR 3003/50 by Wacker Silicone of Adrian, Mich. and Rhodia Silbione® LSR 4340 by Rhodia Silicones of Ventura, Calif.

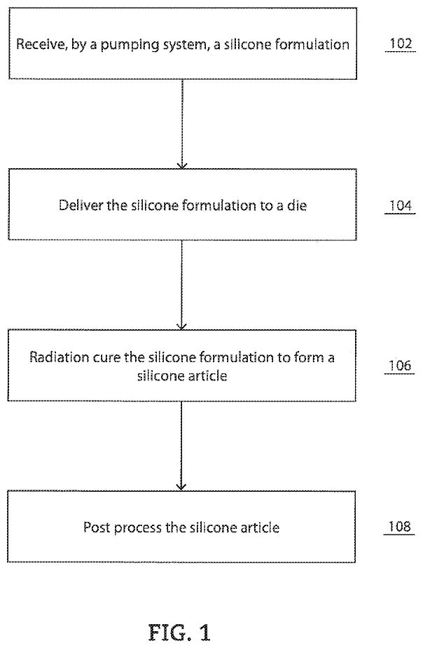

FIG. 1 is a flow diagram of a process 100 to make a silicone article according to an embodiment. At 102, the process 100 includes receiving, by a pumping system, the silicone formulation as described above. The pumping system can include a number of devices that can be utilized to form the silicone article. For example, the pumping system can include a pumping device such as a gear pump, a static mixer, an extrusion device, a radiation cure device, a post-processing device, or any combination thereof.

At 104, the process 100 includes delivering the silicone formulation to a die. In an embodiment, the formation of the silicone article includes providing the silicone formulation from an extruder to a die. Typically, the silicone formulation is mixed before being provided to the die. Any reasonable mixing apparatus is envisioned. In an embodiment, heat may also be applied to the silicone formulation. For instance, any reasonable heating temperature for the components of the silicone formulation may be used to provide a material that can flow from the pumping system and through the die without degradation of the material. For instance, the temperature may be about 50° F. to about 150° F.

At 106, the process 100 includes radiation curing the silicone formulation to form a silicone article. In an embodiment, the radiation curing of the silicone formulation can include subjecting the silicone formulation to one or more radiation sources. Any reasonable radiation source is envisioned such as actinic radiation. In an embodiment, the radiation source is ultraviolet light (UV). Any reasonable wavelength of ultraviolet light is envisioned. In a specific embodiment, the ultraviolet light is at a wavelength of about 10 nanometers to about 500 nanometers, such as a wavelength of about 200 nanometers to about 400 nanometers. Further, any number of applications of radiation energy may be applied with the same or different wavelengths. In a particular embodiment, the radiation curing can occur while the silicone formulation flows through the pumping system, as the silicone formulation flows through the die, as the silicone formulation directly exits the die, or any combination thereof to form the silicone article. The radiation curing provides a continuous process of forming the silicone article. Accordingly, the silicone article may be formed in continuous lengths.

At 108, the silicone article can undergo one or more post processing operations. Any reasonable post processing operations are envisioned. For instance, the silicone article can be subjected to a heat treatment, such as a post-curing cycle. A typical post-curing heat treatment includes a temperature of 400° F. for about 4 hours. In an alternative example, the silicone article is not subjected to a heat treatment. In an example, the silicone article can include a silicone tube structure that is cut into a number of silicone tubes having a specified length.

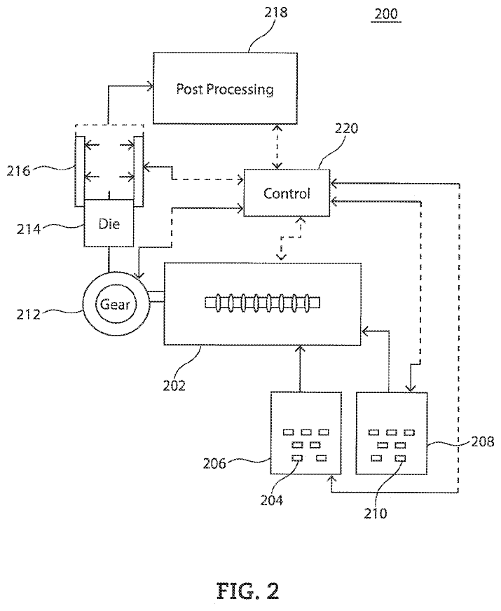

FIG. 2 is a diagram of an embodiment of a pumping system 200 to make silicone articles. In a particular embodiment, the pumping system 200 can implement the process 100 to form the silicone article.

Any pumping system 200 is envisioned. The pumping system 200 may include any reasonable means to deliver the silicone material such as pneumatically, hydraulically, gravitationally, mechanically, and the like, or combinations thereof. In an embodiment, the pumping system 200 can include an extruder 202, such as a single screw extruder or a twin screw extruder. The extruder 202 can melt and/or mix feed material 204 that is contained within at least one drum 206. The feed material 204 can be any portion of the components of the silicone formulation described above used to form the silicone article. In an embodiment, the feed material 204 can be provided to the extruder 202 in the form of a liquid, a solid, such as pellets, strips, powders, and the like, or any combination thereof. The components of the silicone formulation may be fed to the extruder 202 from at least one drum 204. In an embodiment, the pumping system 200 may further contain a static mixer (not illustrated). In a particular embodiment, the static mixer is located between the feed material drum 206 and the extruder 202.

In an embodiment, any number of drums may be envisioned. In a particular embodiment, the feed material 204 can be contained within a first drum 206 and a second drum 208. In an embodiment, the first drum 206 and second drum 208 may include different components of the silicone formulation. In another embodiment, the first drum 206 may include the feed material 204 for the silicone formulation having a first durometer and the second drum 208 may include a feed material 210 including a silicone formulation having a second durometer that is different than the first durometer. For instance, the feed material 204 has a shore A durometer less than about 50 and the feed material 210 has a shore A durometer greater than about 50. In an exemplary embodiment, the feed material 204 is a liquid silicone rubber formulation having a first durometer and the feed material 210 is a liquid silicone rubber formulation having a second durometer that is different than the first durometer. In a particular embodiment, the feed material 204 from the first drum 206 and the feed material 210 from the second drum 208 are pumped into the extruder 202. In a more particular embodiment, the feed material 204 from the first drum 206 and the feed material 210 from the second drum 208 are pumped through a static mixer and then to the extruder 202. For instance, the feed material 204, 210 may be pumped into the extruder 202 from the first drum 206 and the second drum 208 at different ratios or different rates, depending on the properties desired for the final silicone article. In a particular embodiment, the static mixer may provide in-line mixing for controlled viscosity of the mixture of feed material 204, 210 to the extruder 202.

In an embodiment, the extruder 202 is coupled to an optional gear pump 212. In an embodiment, the gears of the gear pump 212 can have any reasonable configuration, such as a double helix design. The gear pump 212 can operate at any reasonable suction pressure and head pressure. The head pressure of the gear pump 212 is typically based at least partly on the components of the feed material 204, 210, the viscosity of the feed material 204, 210, or any combination thereof.

The pumping system 200 can operate at any reasonable speed. For instance, the pumping system 200 can operate at about 10 meters/minute (m/min) to about 100 m/min, about 5 m/min to about 125 m/min, or even about 3 m/min to about 150 m/min. In an embodiment, the speed of the pumping system 200 can be based at least partly on the rate that the feed material 204, 210 are provided to the extruder 202. Although not illustrated, the pumping system 200 may include a portion that is substantially transparent to the radiation source 216. For instance, the extruder 202 may include a portion, such as an extrusion barrel, that is substantially transparent to the radiation source 216. “Substantial transparency” as used herein refers to a material wherein about 1% to about 100%, such as at least about 25%, or even at least about 50% of the radiation source, such as UV light at about 200 nanometers to about 400 nanometers, can radiate through the portion of the pumping system 200 to initiate cure of the silicone formulation. In a more particular embodiment, the transmission is greater than about 50% at about 300 nanometers. In an embodiment, the portion of the pumping system 200, such as a portion of the extruder 202, is a quartz, a glass, a polymer, or combination thereof. The polymer may be, for example, polymethyl methacrylate (PMMA), polystyrene, or combination thereof. Transparency typically is dependent upon the wavelength of the radiation source, the material, and the thickness of the material. For instance, PMMA has about 80% transmission at about 300 nm at 3 mm thickness. For quartz, the transmission may be greater than about 90% from about 200 nm to about 500 nm for a 10 mm thickness.

The pumping system 200 includes a die 214. Although the die 214 is shown attached to the extruder 202, in some embodiments, the die 214 may be a component that is separate from the extruder 202. Prior to flowing through the die 214, the silicone formulation has a viscosity lower than about 2,000,000 centipoise, such as lower than about 1,000,000 centipoise. In an embodiment, the viscosity of the silicone formulation is about 50,000 centipoise to about 2,000,000 centipoise, such as about 100,000 centipoise to about 2,000,000 centipoise, such as about 100,000 centipoise to about 1,000,000 centipoise, or even about 100,000 centipoise to about 500,000 centipoise. In an embodiment, the viscosity is about 200,000 centipoise (cPs) to about 2,000,000 cPs, such as about 200,000 cPs to about 1,000,000 cPs, such as about 500,000 cPs to about 800,000 cPs. In a particular embodiment, the viscosity of the silicone formulation prior to flowing through the die 214 may be controlled by metered pumping of the feed material 204 from the first drum 206 and metered pumping of the feed material 210 from the second drum 208. In a more particular embodiment, the viscosity is controlled by the metered pumping of the feed material 204 from the first drum 206 and metered pumping of the feed material 210 from the second drum 208 through a static mixer. The final properties of the silicone article can thus be controlled during in-line processing, depending on the rate of the metered pumping.

In an embodiment, the silicone formulation is subjected to a source of radiation energy 216 to cure the silicone formulation to form the silicone article. The source of radiation energy 216 can include any reasonable radiation energy source such as actinic radiation. In a particular embodiment, the radiation source is ultraviolet light. The radiation source is sufficient to substantially cure the silicone article. “Substantially cure” as used herein refers to >90% of final crosslinking density, as determined for instance by rheometer data (90% cure means the material reaches 90% of the maximum torque as measured by ASTM D5289). For instance, the level of cure is to provide a silicone article having a desirable shore A durometer. Any shore A durometer is envisioned, such as about 10 to about 80, such as about 20 to about 70, or even about 40 to about 60. In another particular embodiment, the cure is without any heat, such as heat not greater than about 100° C., such as not greater than about 80° C., or even not greater than about 50° C.

The cured silicone article can undergo post processing 218. Any post processing is envisioned. In an embodiment, the post processing 218 can include a heating tower. In an alternative embodiment, the post processing 218 does not include any heating tower. In an embodiment, the post processing 218 can include cutting the silicone article into particular lengths. In another embodiment, the post processing 218 can include wrapping the silicone article into a coil of article.

The pumping system 200 can also include a control system 220 that includes one or more computing devices. The control system 220 can provide signals to one or more of the components of the pumping system 200 to specify operating conditions for the components. For example, the control system 220 can adjust a speed of the pumping system 200. For instance, the control system 220 can adjust the speed of the feed material 204, 210 from the drum 206, 208. In another example, the control system 220 can adjust the level of radiation of the radiation source 216 of the pumping system 200. Further, the control system 220 can adjust any conditions of the gear pump 212.

In certain instances, the signals provided by the control system 220 can be based, at least partly, on feedback information provided by one or more sensors of the pumping system 200. Any reasonable sensor is envisioned. In some embodiments, the one or more sensors can be part of a component of the pumping system 200, such as a pressure sensor of the gear pump 212, a sensor of the drum 206, 210, a sensor of the components providing the radiation source 216, or any combination thereof.

In an illustrative embodiment, the pumping system 200 is organized such that one or more components of the pumping system 200 are arranged in a vertical configuration. For example, the extruder 202, the die 214, and the components of the radiation source 216 are arranged to vertically extrude the silicone article. In a particular embodiment, the silicone article can be formed by extruding the silicone formulation in an upward direction or a downward direction. In a more particular embodiment, the silicone article is formed by extruding the silicone formulation in an upward direction. In an example, the vertical upward extrusion may provide increased dimensional stability to the final silicone article. In an alternative embodiment, the pumping system 200 can be arranged in a horizontal configuration.

The pumping system 200 can operate to form any reasonable silicone article. For instance, any extruded silicone article may be envisioned, also herein described as an “extrudate”. In a particular embodiment, the silicone article is a film, a block, a circular tube, a rectangular tube, a shaped profile of either open or closed geometry, and the like. In an embodiment, the extruded silicone article is a tube. A tube typically includes a proximal end, a distal, and a lumen there through. The proximal end to the distal end defines a length of the tube. The tube further includes an inner diameter that defines an inner surface of the tube and an outer diameter that defines an outside surface of the tube. An exemplary profile includes, but is not limited to, gaskets, seals, and multilumens. The article may include any number of layers. In an embodiment, a multilayer article is produced such as a film, tubing, and the like. In an embodiment, the silicone formulation may be combined with additional components such as reinforcements, marking strips and the like, such as at the point of extrusion. The article may also include a foamed structure.

In a particular embodiment, the pumping system 200 can form silicone tubes that are not achieved by conventional silicone tube manufacturing processes. In particular, the radiation source 216 of the pumping system 200 and the operating parameters for the components of the pumping system 200 are conducive to forming dimensionally accurate tubing that conventional extrusion/heat cure systems are not able to re-produce. Further, controlling the viscosity using first drum 206 and second drum 208 provides in-line processing of the tubing. In a particular embodiment, the radiation source 216 cures the silicone article more rapidly compared to conventional heat cure systems. “Conventional heat cure” as used herein refers to curing via heat at a temperature greater than about 150° C. Additionally, arranging the pumping system 200 such that the tubing is extruded in a vertical direction may contribute to reducing variation in the dimensions of the tubing.

Although a typical pumping system and process is described, any variations may be envisioned that delivers the silicone formulation to the die and cures the silicone formulation via a radiation source. For instance, in-line mixing may be used which includes multiple components of the silicone formulation pumped through a static mixture. In another embodiment, the process may include pumping the silicone formulation directly to a gear pump without the use of an extruder. In yet another embodiment, the process may include pumping the silicone formulation directly to a die without the use of a gear pump. Further, the process may include a window within the apparatus that is substantially transparent to the radiation source for pre-treatment via the radiation source prior to the material flowing through the die.

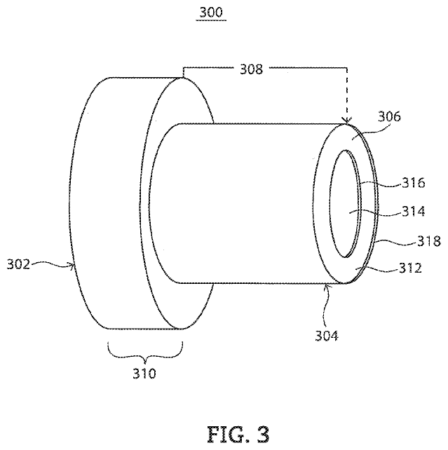

FIG. 3 is a view of a die 300 according to an embodiment. The die 300 includes a distal end 302, a proximal end 304, and a channel 306 there between wherein the silicone formulation flows there through. Typically, the die 300 includes a material that can withstand the radiation source. For instance, the die has any reasonable operating temperature, typically dependent upon conditions such as the material chosen, the rate of cure desired, or combination thereof. In an embodiment, the operating temperature of the die is about 25° C. to about 60° C. In another embodiment, the operation temperature of the die is at least about 60° C., such as about 80° C. to about 200° C. In yet another embodiment, the operating temperature of the die is less than about 25° C. When the radiation source is UV light, it is desirable for at least a first portion 308 of the die 300 to have substantial transparency to the radiation source. “Substantial transparency” as used herein refers to a material wherein about 1% to about 100%, such as at least about 25%, or even at least about 50% of the radiation source, such as UV light, can radiate through the first portion 308 of the die 300 material to initiate cure of the silicone formulation. In an embodiment, the first portion 308 of the die 300 is a quartz, a glass, a polymer, or combination thereof. The polymer may be, for example, polymethyl methacrylate (PMMA), polystyrene, or combination thereof. With the first portion 308 of the die 300 having substantial transparency to the radiation source, the silicone formulation substantially cures as it flows through the channel 306 and out of the proximal end 304 of the die 300. Although the first portion 308 of the die 300 is illustrated toward the proximal 304 end of the die 300, any portion along the length of the die 300 may be substantially transparent to the radiation source.

In an embodiment, the die 300 further includes a second portion 310. The second portion 310 may be the same or different material than the first portion 308. In a particular embodiment, the second portion 310 may be a metal. Any reasonable metal for a die is envisioned. In an embodiment, the first portion 308 of the die and the second portion 310 of the die may be the same material. For instance, the first portion 308 and the second portion 310 may both be a material that is substantially transparent to the radiation source. In another embodiment, the first portion 308 and the second portion 310 may both be a material that is not substantially transparent to the radiation source, such as when the radiation source is not ultraviolet light or when the portion of the pumping system, such as a portion of the extruder, is substantially transparent to the radiation source. In this embodiment, the first portion 308 and the second portion 310 may be a metal.

Although the channel 306 of the die may be in any reasonable shape to form the silicone article, FIG. 3 illustrates a die having a cylindrical ring shape 312 extending from the distal end 302 to the proximal end 304 of the die 300. In a particular embodiment, the die 300 may be shaped to form silicone tubing. As illustrated, the die 300 includes an interior insert 314 having an outside diameter 316 smaller than an outside diameter 318 of the cylindrical ring shape 312. In an embodiment, the interior insert 314 is a core pin. In an embodiment, a distance between the outside diameter 318 of the cylindrical ring shape 312 and the outside diameter 316 of the interior insert 314 is about 1.0 mm to about 10.0 mm, such as about 1.0 mm to about 7.0 mm, such as about 2.0 mm to about 5.0 mm. In an embodiment, the tube has a total thickness of at least about 3 mils to about 50 mils, such as about 3 mils to about 20 mils, or even about 3 mils to about 10 mils.

Although not illustrated, the interior insert 314 may be configured to provide a multilayer tubing. Any method of forming a tube or extrusion is envisioned. In an embodiment, the interior insert 314 may include a distal end, a proximal end, and a channel therebetween, the channel having a cylindrical ring shape. For instance, a polymer may be extruded through the interior insert 314 of the die 300 to form an inner polymer tube within the silicone tube. In a particular embodiment, the polymer may be co-extruded through the interior insert 314 of the die 300 while the silicone material is extruded through the cylindrical ring shape 312 of the die 300. Any reasonable polymer is envisioned. In a particular embodiment, the polymer may be a fluoropolymer, a polyvinyl chloride, a polyolefin elastomer, or combination thereof. An exemplary fluoropolymer may be formed of a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof.

Once formed and cured, particular embodiments of the above-disclosed apparatus advantageously exhibit desired properties such as increased productivity and an improved silicone article. For example, the final properties of the silicone article can be designed during in-line production. Furthermore, the extrusion and cure of the silicone article provides a final product with low shrinkage and reduced bubbling in the silicone article, compared to a silicone article that is conventionally extruded and heat cured. Although not being bound by theory, it is believed that the radiation cure provides instant penetration of the radiation into the silicone formulation and curing of the bulk of the silicone formulation concurrently. Furthermore, due to the no or low heat involved in the radiation curing with the present invention, less bubbling is produced than with conventional heat curing that involves heat transfer from the outer surface of the article into the interior bulk of the silicone material, which allows more bubbles to be formed. In a particular embodiment, the silicone article has desirable transparency. For instance, the transparency is about 80% at 300 nm with 1 mm thickness of silicone.

In a further embodiment, the curing related to the radiation curing within the pumping system, through the die, directly exiting the die, or combination thereof makes it possible to build green strength in silicone faster. The radiation curing increases the viscosity of the silicone formulation as it flows through the die, as it directly exits the die, or combination thereof. The rate of the increase in viscosity is dependent upon the silicone formulation and catalyst chosen as well as when the radiation source is applied to the silicone formulation. As the silicone formulation flows out of the channel, the silicone formulation is substantially cured to form a silicone article. Accordingly, the radiation curing provides dimensional stability to the radiation cured silicone article.

In an exemplary embodiment, the silicone articles can have a specified dimensional accuracy. With silicone tubing, for instance, the tubing is expected to deliver or remove fluids at a specified rate. The dimensions of the silicone tubing can affect the flow rate of fluid pumped by the devices. For example, when the inner diameter of the silicone tubes is not dimensionally accurate, the amount of fluid delivered may be different than the expected amount. In an embodiment, the dimensional accuracy can be measured by a standard deviation of an inner diameter of the silicone tube being no greater than about 1.1% of an average inner diameter of the silicone tube over a length of the silicone tube, such as over an entire length of the silicone tube. In certain embodiments, the standard deviation of the inner diameter may be no greater than about 0.9% of the average inner diameter, such as no greater than about 0.7% of the average inner diameter, such as no greater than about 0.6% of the average inner diameter, or even not greater than about 0.5% of the average inner diameter of the silicone tube over a length of the silicone tube, such as about 20 meters. In an embodiment, the standard deviation is over an entire length of the silicone tube.

Additionally, the dimensional accuracy can be measured by a standard deviation of a wall thickness of the silicone tube being no greater than about 3.6% of an average wall thickness of the tube over a length of the tube, such as the entire length of the tube. In particular embodiments, the standard deviation of the wall thickness may be no greater than about 3.0% of the average wall thickness, such has no greater than about 2.4% of the average wall thickness, such as no greater than about 1.8% of the average wall thickness, or even not greater than about 0.8% of the average wall thickness over the length of the tube, such as the entire length of the silicone tube. In a particular embodiment, the dimensional accuracy of the extruded and radiation cured silicone tube provides desirable concentricity. In comparison, a conventional molding process and injection molding pressures typically create tubes with undesired variable concentricity at a length greater than about 0.3 meters (about 1.0 foot).

The final properties of the extruded and cured silicone tube provide desirable properties such as a desirable pump life and a desirable flow rate to provide a specified amount of fluid. The average pump life of the silicone tube is greater than about 50 hours, such as greater than about 60 hours, or even greater than about 70 hours, when tested on a Cole Parmer Masterflex L/S 16 pump with standard head at 600 rpm. In an exemplary embodiment, the average pump life is greater than 100 hours, when tested on a Cole Parmer Masterflex L/S 16 pump with standard head at 600 rpm. Due to the dimensional accuracy of the silicone tube, an amount of fluid can be dispensed within a particular tolerance in relation to the amount specified. For instance, the silicone tube has improved flow rate stability. In a particular embodiment, the silicone tube has a desirable flow rate stability for peristaltic pumping applications. In an example, the absolute flow rate change is about 0% to about 10%, such as about 0% to about 5%, or even about 0% to about 2%, measured after 24 hours using a precision peristaltic pump such as an enteral feeding pump or infusion pump.

Extrusion of the silicone article provides an article in continuous lengths. Any reasonable length is envisioned. For instance, an article has a length of at least about 0.25 meters (m), at least about 0.5 meters, at least about 1.0 meter, at least about 10.0 meters, at least about 50.0 meters, of even up to at least about 300.0 meters. In comparison, a conventional molding process forms articles in a finite length depending on the length of the mold. It should also be noted that the silicone tube is free from any visual defects found on tubes formed by a conventional molding process. For example, the silicone tube structure does not include a knit line, a parting line, flash, or combination thereof. For instance, knit lines are absent from one or more ends of the body of the tube, such as a distal end, a proximal end, or both.

The silicone article further provides physical-mechanical properties such as desirable loss modulus, tensile modulus, compression set, and the like. For instance, the silicone article has desirable loss modulus, tensile modulus, compression set compared to a conventional high consistency rubber, such as a conventional extruded high consistency rubber formulation. For instance, the silicone article has a low loss modulus compared to a conventional high consistency rubber (HCR), such as a conventional extruded high consistency rubber formulation. In an embodiment, the loss modulus of the silicone article is about 0.01 MPa to about 1.0 MPa, such as about 0.02 MPa to about 0.5 MPa, or even about 0.05 MPa to about 0.4 MPa, measured at 25° C. at 1 hertz on a typical dynamic mechanical analyzer, such as a TA Instruments Q800 dynamic mechanical analyzer.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1

Example 1 (Single Finished UV LSR, Through Extruder and Gear Pump)

An LSR formulation is prepared using 97.6 wt % of a vinyl containing silicone base (custom made at a Toll Manufacturer, vinyl content at 0.04 mmol/g and filler content at about 25% by wt), 1.2 wt % of a hydride crosslinker (such as Andersil XL-10) and 1.2 wt % master batch of UV activatable catalyst such as (Trimethyl)methylcyclopentadienyl platinum (IV), equivalent to about 12 ppm of the catalyst. The compounding is done in a high shear mixer like Ross mixer, following typical compounding procedures. Viscosity of the composition is about 300,000 centipoise to about 500,000 centipoise. The mixing can be done a couple of days before extrusion with the composition stored indoors in an opaque container.

Viscosity for the silicone formulations are measured via a steady shear rate sweep with data reported for 10 1/s (sec⁻¹) or via a frequency sweep at a comparable strain rate. For instance, viscosity is measured via a TA Instruments AR-G2 rotational rheometer with the following steady shear rate sweep test parameters: Geometry: Cone and Plate (40-mm) or parallel plate (25 mm); Gap: 0.058 mm (cone and plate) or 700-800 mm (parallel plate); Shear Rate: 0.1˜100 1/s (Temperature: 25° C., report 10 l/s value); Atmosphere: Air. The frequency sweep test parameters are as follows: Geometry: Cone and Plate (40-mm) or parallel plate (25 mm); Gap: 0.058 mm (cone and plate) or 700-800 mm (parallel plate); Frequency: 100-0.5 rad/s; Strain: 0.1%; Temperature: 25° C.; Atmosphere: Air.

When ready for production, the compound is delivered to a single screw extruder via a precision pump or a pneumatic delivery system.

The extruder is operated using a 60 mm screw at 8 rpm to deliver the extrudate. The extrudate is passed through a circular die to form a tube of size 6.35 mm ID by 9.52 mm OD at a rate of 10 meters per minute. The tube is irradiated at the point of exit using a UV bulb such as an H bulb available from Fusion UV. Power is adjusted to give desirable cure rate.

Cured tubing is then collected and measured using an x-ray measurement system. A typical standard deviation of the data measured for ID is about 0.008 mm. A typical standard deviation of the data measured for OD is about 0.009 mm.

### Example 2

An LSR formulation is prepared using 3 vinyl containing silicone bases (custom made at a Toll Manufacturer, vinyl content from 0.03˜0.09 mmol/g; and blended to give a final vinyl content at about 0.06, a typical LSR viscosity, and a filler content at about 25% by wt), 1.0 wt % of two hydride crosslinkers combined (such as Andersil XL-10) and 1.5 wt % master batch of UV activatable catalyst such as (Trimethyl)methylcyclopentadienyl platinum (IV), equivalent to about 15 ppm of the catalyst. The compounding is done in a high shear mixer like Ross mixer, following typical compounding procedures. Viscosity of the composition is about 300,000 centipoise to about 500,000 centipoise. The mixing can be done a couple of days before extrusion with the composition stored indoors in an opaque container.

The composition is cured using the conditions of Example 1. The silicone tubes formed are then tested for tubing properties such as pump life and % flow rate change. Further, the tubing properties of the silicone tubes are compared to a Sani-Tech® STHT®, a liquid silicone rubber that is platinum cured via thermal treatment. Sani-Tech® STHT® is available from Saint-Gobain Performance Plastics.

The test conditions are as follows: 50 durometer tubing samples 0.125″ID×0.255″ OD×0.065″ wall in a Cole Parmer Masterflex L/S 16 pump with standard head at 600 rpm. Each test is run until failure as detected by leakage. The flow readings are taken daily with a McMillan Flo-Meter.

Average pump life for the silicone tube of Example 2 is 71 hours with a standard deviation of 19. Average pump life for the comparative Sanitech® STHT® is 53 hours with a standard deviation of 21. Further, the absolute flow rate of the silicone tube of this example in comparison to Sanitech® STHT® is comparable with a value of about 0% to about 10%, such as about 0% to about 5%, or even about 0% to about 2%.

Dimensional stability of the pump tube is further compared to a “standard HCR” tubing, Biosil Precision, which is a platinum cured high consistency rubber (HCR) silicone that is cured via thermal treatment available from Saint-Gobain Performance Plastics. Tubing samples are 0.125″ID×0.255″ OD×0.065″ wall.

The dimensions are measured using a Sikora X-RAY 6035 measurement system equipped with an ECOCONTROL 2000 display/control system from Sikora. This is a non-contact measurement system that measures the inner diameter, outer diameter, wall thickness, and eccentricity of the tubing. The tubing is measured continuously at a rate of 28 foot/min. A measurement is taken every second, for a total continuous measurement length of 260 feet of product. (Room conditions are 70+/−2° F. at 50+/−10% RH).

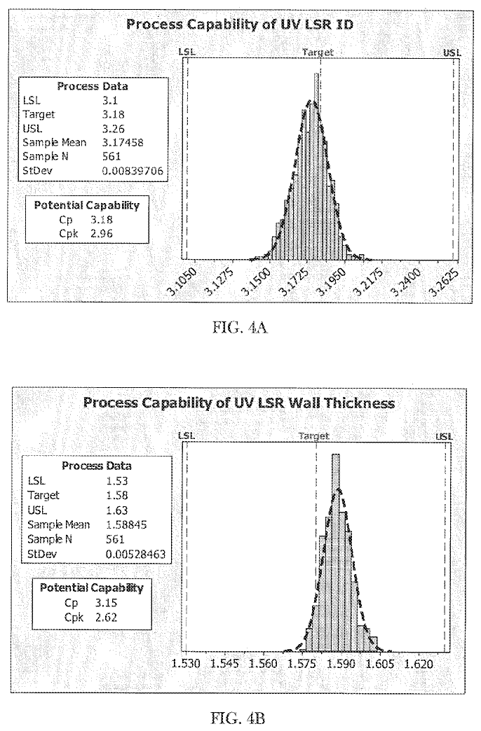

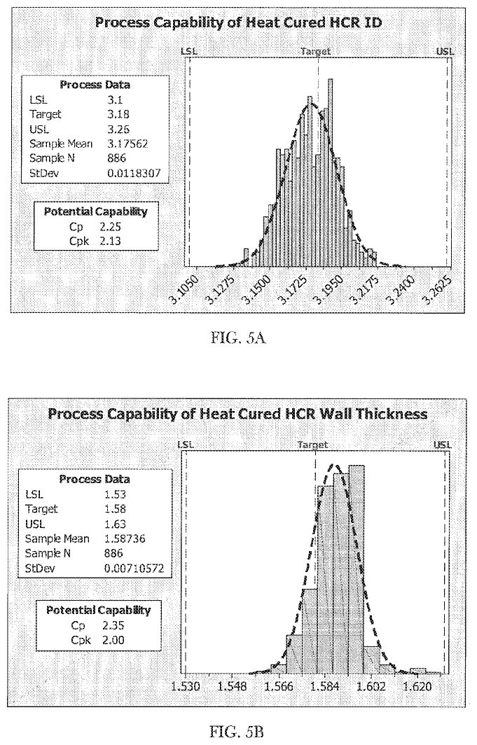

FIGS. 4A and 4B are capability plots for the silicone tubing of Example 2 for the inner diameter (ID) and wall thickness, respectively. FIGS. 5A and 5B are capability plots for the HCR comparison sample for the inner diameter (ID) and wall thickness, respectively. All plots are taken of measurements in millimeters. As per the plots, the dimensional stability of the silicone tubes cured by ultraviolet radiation are comparable or better than compared to the standard HCR tubing. The higher Cₚ and Cₚₖ values for the inner diameter and wall thickness of the tubes of Example 2 indicate that the variation of the LSR UV cured process is lower than that of the HCR conventionally cured process. Thus, the dimensional accuracy of silicone tubes produced by the Example 2 is improved over that of the standard HCR tubing.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Item 1. An apparatus for forming a silicone article, comprising a pumping system to deliver a silicone formulation to a die, the silicone formulation having a viscosity of less than about 2,000,000 centipoise; the die having a distal end, a proximal end, and a channel there between, wherein the silicone formulation flows through the channel of the die; and a source of radiation energy, wherein the radiation energy substantially cures the silicone formulation as the silicone formulation flows out the channel of the die to form the silicone article.

Item 2. The apparatus according to Item 1, wherein the die has an operating temperature of about 25° C. to about 60° C.

Item 3. The apparatus according to Item 1, wherein at least a first portion of the die, a portion of the pumping system, or combination thereof is substantially transparent to a radiation source.

Item 4. The apparatus according to Item 3, wherein at least about 50% of the radiation source at about 300 nanometers radiates through the at least first portion of the die, the portion of the pumping system, or combination thereof.

Item 5. The apparatus according to Item 3, wherein the first portion of the die, the portion of the pumping system, or combination thereof is a quartz, a glass, a polymer, or combination thereof.

Item 6. The apparatus according to Item 5, wherein the polymer is polymethyl methacrylate (PMMA), polystyrene, or combinations thereof.

Item 7. The apparatus according to Item 1, wherein the radiation source is ultraviolet light.

Item 8. The apparatus according to Item 1, wherein the silicone formulation has a viscosity of about 200,000 cPs to about 1,000,000 cPs, prior to flowing through the distal end of the die.

Item 9. The apparatus according to Item 1, wherein the silicone formulation is a liquid silicone rubber (LSR), a room temperature vulcanizable silicone, (RTV), or combination thereof.

Item 10. The apparatus according to Item 1, wherein the silicone article has a Shore A durometer of about 10 to about 80 as the silicone formulation exits the proximal end of the die.

Item 11. The apparatus according to Item 1, wherein a second portion of the die is a metal.

Item 12. The apparatus according to Item 1, wherein the die has a cylindrical ring shape extending from the distal end to the proximal end of the die.

Item 13. The apparatus according to Item 1, wherein the die further includes an interior insert having a outside diameter smaller than an outside diameter of the cylindrical ring shape.

Item 14. The apparatus according to Item 13, wherein the distance between the outside diameter of the cylindrical ring shape and the outside diameter of the interior insert is about 1.0 mm to about 10.0 mm.

Item 15. The apparatus according to Item 13, wherein the interior insert has a distal end, a proximal end, and a channel there between.

Item 16. The apparatus according to Item 1, wherein the silicone formulation is formed into a tube.

Item 17. A method of forming a silicone article, comprising providing a silicone formulation within a pumping system, wherein the silicone formulation has a viscosity of less than about 2,000,000 centipoise; providing a die having a distal end, a proximal end, and a channel there between; delivering the silicone formulation from the pumping system and through the channel of the die; and irradiating the silicone formulation with a radiation source to substantially cure the silicone formulation as the silicone formulation flows out the channel of the die to form the silicone article.

Item 18. The method according to Item 17, wherein delivering the silicone formulation is at an operating temperature of about 25° C. to about 60° C.

Item 19. The method according to Item 17, wherein at least a first portion of the die, a portion of the pumping system, or combination thereof is substantially transparent to a radiation source.

Item 20. The method according to Item 19, wherein at least about 50% of the radiation source at about 300 nanometers radiates through the at least first portion of the die, the portion of the pumping system, or combination thereof.

Item 21. The method according to Item 19, wherein the first portion of the die, the portion of the pumping system, or combination thereof is a quartz, a glass, a polymer, or combination thereof.

Item 22. The method according to Item 21, wherein the polymer is polymethyl methacrylate (PMMA), polystyrene, or combinations thereof.

Item 23. The method according to Item 17, wherein the radiation source is ultraviolet light.

Item 24. The method according to Item 17, wherein the silicone formulation is delivered to the distal end of the die at a viscosity of about 200,000 cPs to about 1,000,000 cPs.

Item 25. The method according to Item 17, wherein the silicone material is a liquid silicone rubber (LSR), a room temperature vulcanizable silicone, (RTV), or combination thereof.

Item 26. The method according to Item 17, wherein the silicone article has a Shore A durometer of about 10 to about 80 as the silicone formulation exits the proximal end of the die.

Item 27. The method according to Item 17, wherein a second portion of the die is a metal.

Item 28. The method according to Item 17, wherein the die has a cylindrical ring shape extending from the distal end to the proximal end of the die.

Item 29. The method according to Item 28, wherein the die further includes an interior insert having a outside diameter smaller than an outside diameter of the cylindrical ring shape.

Item 30. The method according to Item 29, wherein the distance between the outside diameter of the cylindrical ring shape and the outside diameter of the interior insert is about 1.0 mm to about 10.0 mm.

Item 31. The method according to Item 29, wherein the silicone formulation is formed into a tube.

Item 32. The method according to Item 31, further comprising forming the silicone formulation tube over a polymer.

Item 33. The method according to Item 32, wherein the polymer is a fluoropolymer.

Item 34. The method according to Item 32, wherein the silicone formulation and the polymer are co-extruded.

Item 35. The method according to Item 32, wherein the polymer is in the form of a tube having a fluid channel there through.

Item 36. An extruded silicone tube comprising a distal end, a proximal end, and a lumen there through having a continuous length from the distal end to the proximal end of at least about 0.5 meters; wherein the silicone tube comprises a cured silicone formulation having a viscosity of less than about 2,000,000 centipoise prior to cure.

Item 37. The silicone tube of Item 36, wherein the tube has a length of at least about 10.0 meters.

Item 38. The silicone tube of Item 36, having a standard deviation of an inner diameter of the silicone tube no greater than about 1.1% of an average inner diameter of the silicone tube over an entire length of the silicone tube.

Item 39. The silicone tube of Item 36, having a standard deviation of a wall thickness of the silicone tube no greater than about 3.6% of an average wall thickness of the silicone tube over an entire length of the tube.

Item 40. The silicone tube of Item 36, wherein the tube is free of a parting line, a knit line, flash, or combination thereof.

Item 41. The silicone tube of Item 36, wherein the tube is radiation cured.

Item 42. The silicone tube of Item 36, having a filler content of up to about 80% by weight of the total weight of the silicone formulation.

Item 43. The silicone tube of Item 42, wherein the filler content is about 10% by weight to about 50% by weight of the total weight of the silicone formulation.

Item 44. The silicone tube of Item 36, having a crosslink density of about 0.002 mmole/gram to about 0.2 mmole/gram.

Item 45. The silicone tube of Item 44, having a crosslink density of about 0.006 mmole/gram to about 0.1 mmole/gram.

Item 46. The silicone tube of Item 36, having a loss modulus of about 0.01 MPa to about 1.0 MPa, measured at 25° C. at 1 hertz.

Item 47. The silicone tube of Item 46, having a loss modulus of about 0.02 MPa to about 0.5 MPa, measured at 25° C. at 1 hertz.

Item 48. The silicone tube of Item 36, having an absolute flow rate change of about 0% to about 10%, measured after 24 hours using a precision peristaltic pump.

Item 49. The silicone tube of Item 48, having an absolute flow rate change of about 0% to about 5%, measured after 24 hours using a precision peristaltic pump.

Item 50. A silicone extrudate comprising a configuration of a film, a block, a circular tube, a rectangular tube, or a profile; wherein the silicone extrudate comprises a radiation cured silicone formulation having a viscosity of less than about 2,000,000 centipoise prior to cure.

Item 51. The silicone extrudate of Item 50, wherein the profile is shaped with an open geometry or a closed geometry.

Item 52. The silicone extrudate of Item 51, wherein profile is a gasket, a seal, or a multilumen.

Item 53. The silicone extrudate of Item 50, having a filler content of up to about 80% by weight of the total weight of the silicone formulation.

Item 54. The silicone extrudate of Item 53, wherein the filler content is about 10% by weight to about 50% by weight of the total weight of the silicone formulation.

Item 55. The silicone extrudate of Item 50, having a crosslink density of about 0.002 mmole/gram to about 0.2 mmole/gram.

Item 56. The silicone extrudate of Item 55, having a crosslink density of about 0.006 mmole/gram to about 0.1 mmole/gram.

Item 57. The silicone extrudate of Item 50, having a loss modulus of about 0.01 MPa to about 1.0 MPa, measured at 25° C. at 1 hertz.

Item 58. The silicone extrudate of Item 57, having a loss modulus of about 0.02 MPa to about 0.5 MPa, measured at 25° C. at 1 hertz.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method of forming a silicone article, comprising:
providing a silicone formulation within a pumping system, wherein the silicone formulation has a viscosity of less than about 2,000,000 centipoise;
providing a die having a distal end, a proximal end, and a channel there between;
delivering the silicone formulation from the pumping system and through the channel of the die; and
irradiating the silicone formulation with a radiation source to substantially cure the silicone formulation as the silicone formulation flows out the channel of the die to form the silicone article.

2. The method according to claim 1, wherein delivering the silicone formulation is at an operating temperature of about 25° C. to about 60° C.

3. The method according to claim 1, wherein at least a first portion of the die, a portion of the pumping system, or combination thereof is substantially transparent to a radiation source.

4. The method according to claim 3, wherein at least about 50% of the radiation source at about 300 nanometers radiates through the at least first portion of the die, the portion of the pumping system, or combination thereof.

5. The method according to claim 3, wherein the first portion of the die, the portion of the pumping system, or combination thereof is a quartz, a glass, a polymer, or combination thereof.

6. The method according to claim 5, wherein the polymer is polymethyl methacrylate (PMMA), polystyrene, or combinations thereof.

7. The method according to claim 1, wherein the radiation source is ultraviolet light.

8. The method according to claim 1, wherein the silicone formulation is delivered to the distal end of the die at a viscosity of about 200,000 cPs to about 1,000,000 cPs.

9. The method according to claim 1, wherein the silicone material is a liquid silicone rubber (LSR), a room temperature vulcanizable silicone, (RTV), or combination thereof.

10. The method according to claim 1, wherein the silicone article has a Shore A durometer of about 10 to about 80 as the silicone formulation exits the proximal end of the die.

11. The method according to claim 1, wherein a second portion of the die is a metal.

12. The method according to claim 1, wherein the die has a cylindrical ring shape extending from the distal end to the proximal end of the die.

13. The method according to claim 12, wherein the die further includes an interior insert having a outside diameter smaller than an outside diameter of the cylindrical ring shape.

14. The method according to claim 13, wherein the distance between the outside diameter of the cylindrical ring shape and the outside diameter of the interior insert is about 1.0 mm to about 10.0 mm.

15. The method according to claim 13, wherein the silicone formulation is formed into a tube.

16. The method according to claim 15, further comprising forming the silicone formulation tube over a polymer.

17. The method according to claim 16, wherein the polymer is a fluoropolymer.

18. The method according to claim 16, wherein the silicone formulation and the polymer are co-extruded.

19. The method according to claim 16, wherein the polymer is in the form of a tube having a fluid channel there through.

20. The method according to claim 1, wherein the silicone article comprises a distal end, a proximal end, and a lumen therethrough having a continuous length from the distal end to the proximal end of at least about 0.5 meters.
